(19) United States
(12) Patent Application Publication
(10) Pub. No.: US 2012/0042963 A1
(43) Pub. Date: Feb. 23, 2012

(54) IN-WALL WATER SERVICE HOUSING

(76) Inventors: Brian D. Sanzone, Novi, MI (US); Mahesh Cheerla, Howell, MI (US); Joseph Schutte, Westland, MI (US); Joseph M. Lehman, New Albany, OH (US); Jeffrey Robert Burger, Bexley, OH (US); Paul Perry Kolada, Bexley, OH (US); Nathan Daniel Durflinger, Youngstown, OH (US)

(21) Appl. No.: 12/859,838

(22) Filed: Aug. 20, 2010

(51) Int. Cl. F16K 43/00

(52) U.S. Cl. 137/315.01

(57) ABSTRACT

A retrofit or new installation kit or apparatus has a junction box, a supply pipe that attaches to a quick-connect fitting inside the junction box that attaches to a valve within the junction box. The valve within the junction box has a stub-out that connects to the quick-connect fitting.

### TECHNICAL FIELD

This application relates to plumbing fittings and more particularly to plumbing fittings that are disposed within walls.

### BACKGROUND OF THE INVENTION

Many homes are equipped with appliances, such as clothes washers, that require hot and cold water for proper functioning. Typically, pipes disposed between wall studs extend towards the washer. In older applications, water supply pipes and a drain pipe were threaded through the drywall. In newer applications, the water inlets and the drain pipe are disposed in a junction box disposed in the wall. Feeder hoses extend from the junction box to the appliance and vice-versa. The supply pipes are valved within the junction box to allow a user to turn the water supply to the washer on and off as needed. The valves are provided to minimize a possibility that a feeder hose from the junction box to the washer would rupture.

Over time, the valves themselves may fail and need replacement. The valves were typically soldered to supply pipe outside the junction box.

### SUMMARY OF THE INVENTION

According to an embodiment of the invention, an apparatus for mounting a valve in a wall has a junction box having an opening for receiving a fluid therethrough, a body disposed within the opening, the body forming a seal for minimizing a flow of fluid through the opening, a first quick connect fitting integrally attaching to the body for removably attaching to a valve within the junction box and a second quick connect fitting integrally attaching to the body for removably attaching to a fluid supply outside of the junction box.

According to another embodiment, an extension pipe is provided to channel water from a supply pipe to a valve within a junction box and attach to the supply pipe and the valve by means of a quick connect fitting.

By using the quick-connect fittings and the right sized junction box, any further replacement of a valve will not require detailed construction or replacement.

These and other features of the present invention can be best understood from the following specification and drawings, the following of which is a brief description.

### BRIEF DESCRIPTION OF THE DRAWINGS

FIG. 1 shows a prior art side view of an in-wall junction box housing valves to control flow to a washer or the like.

FIG. 2 is a perspective, exploded view of junction box and supply line.

FIG. 2A is a perspective, assembled front view of the junction box of FIG. 2.

FIG. 2B is a perspective, assembled side view of the junction box of FIG. 2A.

FIG. 3 shows a perspective view of a connector used in FIGS. 2, 2A and 2B.

### DETAILED DESCRIPTION OF THE PREFERRED EMBODIMENT

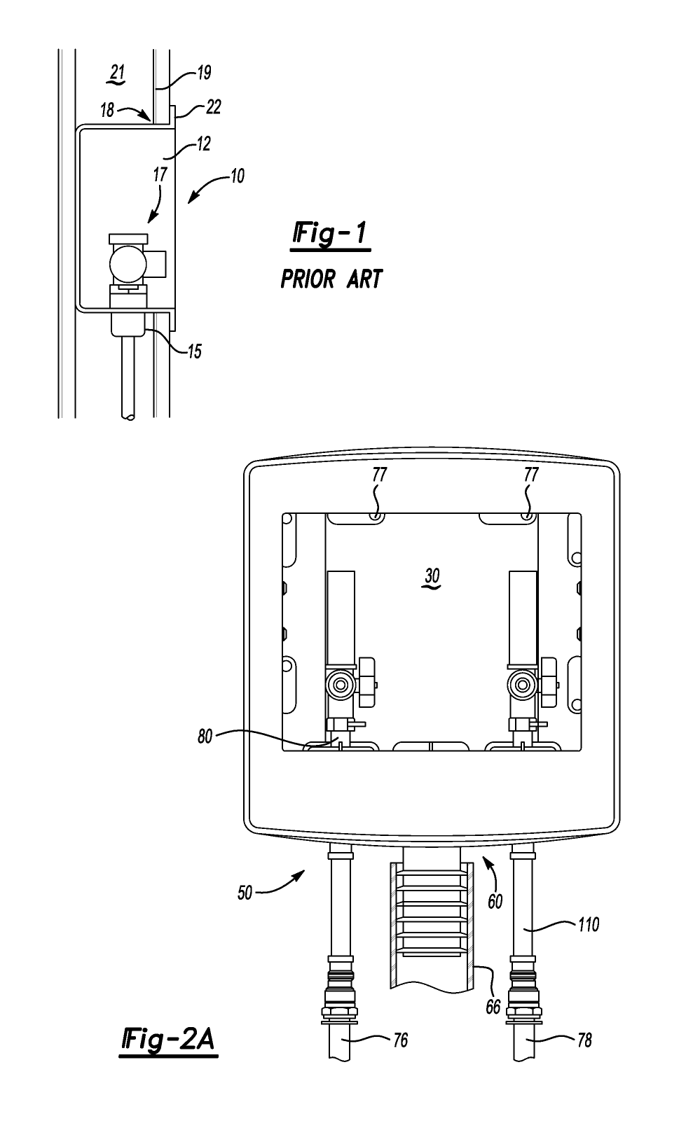

Referring to FIG. 1, the prior art embodiment of a water junction box 10 is shown. The prior art water junction box 10 shows a box 12, a soldered joint 15 to which a valve 17 is connected within the box. The water junction box 10 attaches to the drywall 19 or studs 21 via flanges 22 as is known in the art.

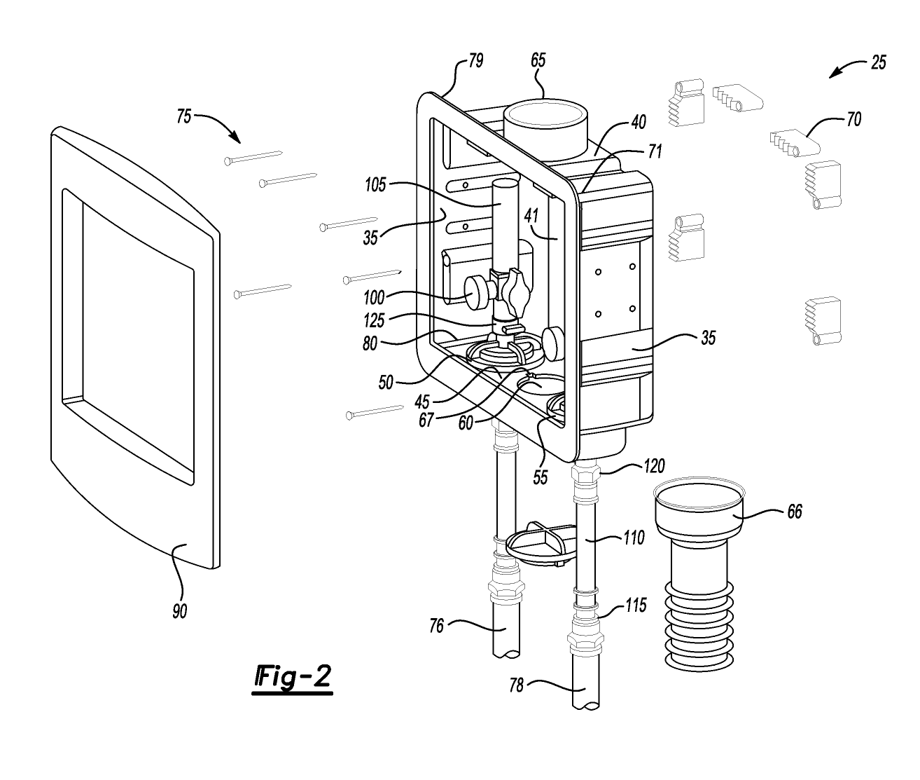

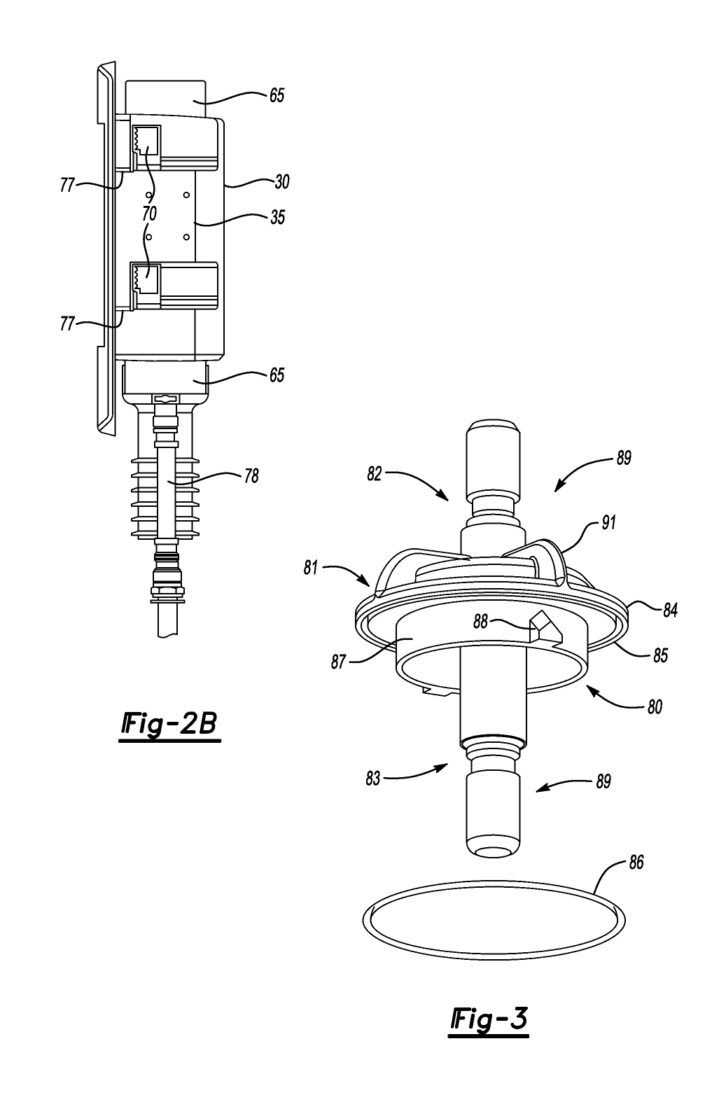

Referring now to FIGS. 2, 2A and 2B, an embodiment of a junction box 25 and a kit therefore is shown. The junction box 25 has a back wall 30, sidewalls 35, a top wall 40 and a bottom wall 45. The junction box 25 has a hot inlet opening 50, a cold inlet opening 55, as will be discussed herein, and a drain opening 65 in bottom wall 45 to carry water away from a clothes washer (not shown) to a drainpipe 66. The drain opening 65 has a downward depending circular flange 85 that forms a tight fit with the drain fitting 66 so that leaks do not occur therearound. There is also a drain opening 65 in the top wall 40 as will be discussed hereinbelow. Each of the hot inlet openings and cold inlet openings have a pair of grooves 67 therein as will be discussed herein.

Six tabs 70 anchor the junction box 25 to the drywall 19 by means of screws 75 as is known in the art. After the junction box 25 is placed in a hole in the wall, as will be discussed hereinbelow, the screws 75 rotate in holes 77 and into the tabs 70. As the screws 75 rotate, the tabs 70 rotate to become perpendicular to the junction box 25 and are pulled towards the front of the junction box to clamp the drywall between a flange 79 attaching to the front 71 of the junction box 25 and the tabs 70 as is known in the art.

Though use with a clothes washer is contemplated herein, a junction box 25 as disclosed herein may also be usable anywhere fluid, such as water or a gas, is transported for use from inside a wall to outside a wall and control of flow from inside to the outside of a wall is desired.

Some installations, like in basements, require the hot inlet pipe 76 and the cold inlet pipe 78 to descend to the junction box 25 from above. The junction box 25 is then upended so that the drain opening in the top wall 40 of the junction box 25 now extends beneath the junction box and the hot inlet pipe 76 and the cold inlet pipe 78 enter the junction box via the upended bottom wall 45 from above. Drains 65 that attach to drain fitting 66 are disposed downwardly.

The back wall 30 and the sidewalls 35 have a length and width that is longer and wider than the prior art water junction box 12. For example, comparing the drawings of FIG. 1 and FIGS. 2, 2A and 2B, the junction box 25 has extra length because after a worn valve 17 is removed and the soldered fitting 15 is removed, the hot and cold inlet pipes 76, 78 may not have enough length to extend through the water junction box 12. A longer and wider junction box provides room to remove drywall to remove existing pipe without creating a major reconstruction project. A junction box cover 90 is provided that is designed to extend to a length and width that is greater than the length of the sidewalls 35 and the back wall 41 and width of the junction box 25 to cover any hole caused by such removal of the drywall (not shown).

Referring now to FIG. 2, a coupler 80 is shown. The coupler 80 has a body 81 that is disposed in openings 50 and 55. The body 81 has a flange 84 and an integrally formed first male extension 82 extending upwardly and an integrally formed second male extension 83 extending downwardly therefrom. The flange has a groove 85 disposed therein for receiving an o-ring 86. The flange 84 has a cylinder 87 extending downwardly therefrom having a pair of cam surfaces 88 extending outwardly therefrom. The body has a plurality of ridges 91 for grasping the body 81. Each of the extensions 82, 83 have a plurality of raised portions 89 for cooperating with quick connectors as will be discussed herein. The cam surfaces 88 extend through grooves 67 to attach the body 81 to the bottom wall 45. The body 81 is rotated by grasping and turning ridges 91 after insertion of cam surfaces 88 to lock the connector to the bottom wall 45 and seal the o-ring 86 against the bottom wall for minimizing a flow of fluid through said opening 50, 55. The first and second male extensions 82, 83 are essentially quick connect fittings for removably attaching to a valve 100 (see FIG. 1) and a hammer arrestor 105 within said junction box 25 and for removably attaching to a risers 110 removeably attaching to a fluid supplies such has the inlet pipes 76, 78 outside of said junction box 25.

The hot inlet pipe 76 and the cold inlet pipe 78 end behind the drywall 19. A riser 110 attaches at a riser first quick connect fitting 115 to the hot inlet pipe 76 and at a riser second quick connect fitting 120 attaches to the second male extension 83. The first male extension 82 attaches to the valve 100 having a valve quick connect fitting 125.

A quick-connect fitting, such as a compression fitting, or an easy-to-use fitting such as a SureConnect™ or a Pushconnect™ fitting as may be obtained from BrassCraft Manufacturing Company of Novi, Mich. may be used. Using an easy to use fitting allows a user to easily install the valve 100 and the risers 110 to the inlet pipes 76, 78 without having to manipulate wrenches that may twist and damage pipes in a in a small area. A junction box cover 90 clips on to the front of the junction box 25 as is known in the art.

Although a combination of features is shown in the illustrated examples, not all of them need to be combined to realize the benefits of various embodiments of this disclosure. In other words, a system designed according to an embodiment of this disclosure will not necessarily include all of the features shown in any one of the Figures or all of the portions schematically shown in the Figures. Moreover, selected features of one example embodiment may be combined with selected features of other example embodiments.

The preceding description is exemplary rather than limiting in nature. Variations and modifications to the disclosed examples may become apparent to those skilled in the art that do not necessarily depart from the essence of this disclosure. The scope of legal protection given to this disclosure can only be determined by studying the following claims.

What is claimed is:

1. An apparatus for mounting a valve in a wall comprising:
a junction box to be installed in a wall, said junction box having an opening for receiving a fluid supply therethrough,
a body disposed within said opening, said body forming a seal for minimizing a flow of fluid through said opening,
a first quick connect fitting integrally attaching to said body for removably attaching to a valve within said junction box and a second quick connect fitting integrally attaching to said body for removably attaching to a fluid supply outside of said junction box.

2. The apparatus of claim 1 further comprising:
a drain opening disposed in a floor of said junction box for draining fluid from said junction box, wherein said floor is tilted downwardly from said opening to said drain opening.

3. The apparatus of claim 1 wherein said fluid supply is a pipe.

4. The apparatus of claim 3 wherein said pipe attaches to said second quick connect by a flexible hose having a mating quick connect fitting with said quick connect fitting.

5. The apparatus of claim 1 wherein said junction box has an opening in said top and in said bottom of said junction box.

6. The apparatus of claim 5 wherein each of said ends of said extension each have a quick-connect fitting

7. The apparatus of claim 4 wherein said junction box has a drain opening.

8. The apparatus of claim 7 wherein said drain opening is attached to a drainpipe outside said junction box by an extension tube.

9. The apparatus of claim 8 wherein said extension tube has a mushroom shaped attachment that fits within said drainpipe.

10. The apparatus of claim 1 further comprising a junction box cover, said junction box cover having a length and width greater than a length and width of said junction box.

11. The apparatus of claim 1 further comprising a connector for connecting to a wall said connector including an erose surface for driving into said drywall.

12. The apparatus of claim 1 wherein said opening is in a top wall of said junction box.

13. The apparatus of claim 1 wherein said fluid is water.

14. The apparatus of claim 1 wherein said body is removably attached to said box by rotation thereof.

15. A kit for retrofitting a fluid junction junction box within a wall comprising:
a junction box having an opening,
a valve having a quick connect opening, and
a body to be disposed within said opening to form a seal to minimize a flow of fluid through said opening, said body having a first quick connect fitting integrally attaching to said body for removably attaching to said valve within said junction box and a second quick connect fitting integrally attaching to said body for removably attaching to a fluid supply outside of said junction box.

16. The kit of claim 15 wherein said kit further comprises a cover for said junction box that is longer than said junction box.

17. The kit of claim 15 wherein said kit further comprises a drain connector.

18. The kit of claim 17 wherein said drain connector has an end having a shape for forming an interference fit within a drain pipe outside said junction box.

19. The kit of claim 16 wherein said drain connector has a second end for attaching to an opening in said junction box.

20. The kit of claim 15 wherein said junction box has a connector for connecting to a wall.

21. The kit of claim 15 wherein said fluid is water.

22. The apparatus of claim 1 wherein said body is adapted to be removably attached to said box by rotation thereof.
